(19) United States
(12) Patent Application Publication
(10) Pub. No.: US 2011/0289784 A1
(43) Pub. Date: Dec. 1, 2011

(54) SPRING BIASED LIGHTWEIGHT ERGONOMIC NIPPER WITH REPLACEABLE BLADES TO ACCOMMODATE SMALLER HANDS AND ONE-HANDED USE

(76) Inventor: David Thomas Jones, Bechtelsville, PA (US)

(21) Appl. No.: 12/790,946

(22) Filed: May 31, 2010

(51) Int. Cl. B26B 17/00

(52) U.S. Cl. 30/175

(57) ABSTRACT

A nipper is disclosed having lightweight handles which are ergonomically shaped narrowly to accommodate smaller hands or one-handed use, and biased outwardly by a torsion type spring which additionally limits the open handle width. The nipper utilizes carbide tool steel blades affixed with fasteners for easy replacement. The nipper has a friction reducing bushing at the pivot for ease of movement.

### BACKGROUND OF THE INVENTION

The present invention is related to the field of cutting nippers and more specifically to farrier nippers which have lightweight handles biased with a spring, replaceable blades, and ergonomically shaped for users with small hands or to be used one-handedly.

The design for nippers to trim ungulate hooves predates the invention of horseshoes. Horse hooves, like other animal nails or human fingernails, grow constantly. Unlike feral horses who wear their hooves down by traveling many miles each day in search of food, domestic horses are confined and relatively sedentary. Because of this human-caused confinement, it is necessary for humans to trim the horse hooves. Trimming should be done at least every six weeks, preferably more often, before they become too long and cause injury and/or separation of the hoof wall. Conventional available nippers, particularly those used to trim the hooves of horses or other ungulates were designed in the Middle Ages and have continued to this day relatively unchanged. In fact, in some cases modern nippers are still made by hand in a blacksmith forge. They are typically large and heavy and the handles are far apart making them unwieldy for small hands or one-handed use. The perpendicular cutting edges are of the same low carbon steel parent material as the handles and are therefore impossible to grind to a thin edge or to properly harden so that they stay sharp. Most conventional nippers also need to be resharpened by someone highly skilled, require disassembly to sharpen properly and are often outsourced for sharpening. The pivot point is a steel rivet which can rust and cause the nippers to bind. These nippers can fall unrestrictedly open during use necessitating the use of two hands at all times. Currently available spring biased nippers designed for self opening typically have handles even further apart when open.

An improvement to the original nipper design was disclosed by G. P. Whiting (U.S. Pat. No. 532,509) where fastener-affixed blades were shown (underlined italics). However, the described purpose of this disclosure is for the capability of adjusting the blades and the serrations on the bottom of the blades would require that they be thicker than the current claim which requires a very thin blade for precise and easy cutting. Whiting makes no mention of using a harder metal. The current claim has designed the blades to be very hard and sharp; therefore to be easily replaceable, not adjustable.

A spring-biased nipper was disclosed by Jerry Mennicken (U.S. Pat. No. 5,214,854) where a helical spring is used to force the handles apart, and the handles are shown to be uncomfortably wide. This disclosure leaves the handles at their furthest opening and makes no mention of limiting the open distance. This allows the nippers to fall open, necessitating the use of two hands to close. The current claim uses a spring that not only holds the handles apart, but limits the amount they can unintentionally open. The nippers in the Mennicken claim are designed for parallel cutting rather than the perpendicular cutting which is required in hoof trimming, as per the current claim.

An improvement in nippers designed for cutting glass and tiles was disclosed by Bernd Siebenlist of Germany (U.S. Pat. No. 5,361,498) which shows replaceable cutting wheels of carbide. Although the disclosure of carbide steel for the wheel shaped blades is an improvement, the wheels are not applicable for hoof trimming and the nipper handles are very heavy, as required for tile cutting. There is no mention of a spring bias which is required in the current claim.

An improvement in conventional farrier nippers was disclosed by John E. Swanstrom, Jr. (U.S. Pat. No. 5,987,752). This disclosure shows carbide blades attached to mild steel handles, without spring bias and with a steel rivet pivot. In this disclosure the carbide blades are brazed into shelves, described in the disclosure for the purpose of reducing manufacturing cost, not reduced replacement ease, as per the current claim. This would require someone skilled in the art of metal working to replace the blades at a workshop location using special tools. The handles are without spring bias, heavy and ergonomically wide, unlike the current claim.

None of these references contains the features in this current claim with the addition of ergonomically shaped handles and a friction reducing pivot which greatly enhance the ease of use. The combination of all the design elements contained herein distinguishes this application as patentable.

The invention as claimed provides a new design that is lightweight, spring-biased with easily replaceable blades, and ergonomically designed for small hands or one-hand use.

Many people, particularly women, who are doing horse hoof trimming have requested such a design. Currently, the state of the art of hoof trimming tooling remains the best reason for hiring someone else to trim.

### BRIEF SUMMARY OF THE INVENTION

The present invention describes nippers with ergonomically designed handles spaced narrowly apart for small hands or one-handed use. The invention also describes a hidden torsion type spring biased means that assists in opening the nipper handles, but also holds them at a convenient distance apart rather than opening fully. The invention also describes the utilization of lightweight material, such as stainless steel, for the nipper handles and of fastener-affixed carbide blades for easy replacement and to further make cutting easier and more durable. The edges of these carbide blades, being much harder and tougher than the conventional low carbon steel, can be ground thinner than the conventional steel cutting edges for easier cutting and can be replaced rather than resharpened. Also disclosed is the utilization of a friction reducing bushing at the pivot point. The invention will become more apparent from the following Detailed Description which proceeds with reference to the drawings.

### BRIEF DESCRIPTION OF THE DRAWINGS

FIG. 1 is a perspective view of a nipper in the closed position with narrow handles, fastener affixed blades and a torsion type spring attachment.

FIG. 2 is a perspective view of one half of the nippers showing the pivot bearing, the recess for the spring mounting, the hole to install the pivot bushing, and the spring mounting with anchor holes. The two halves are identical.

### DETAILED DESCRIPTION OF THE INVENTION

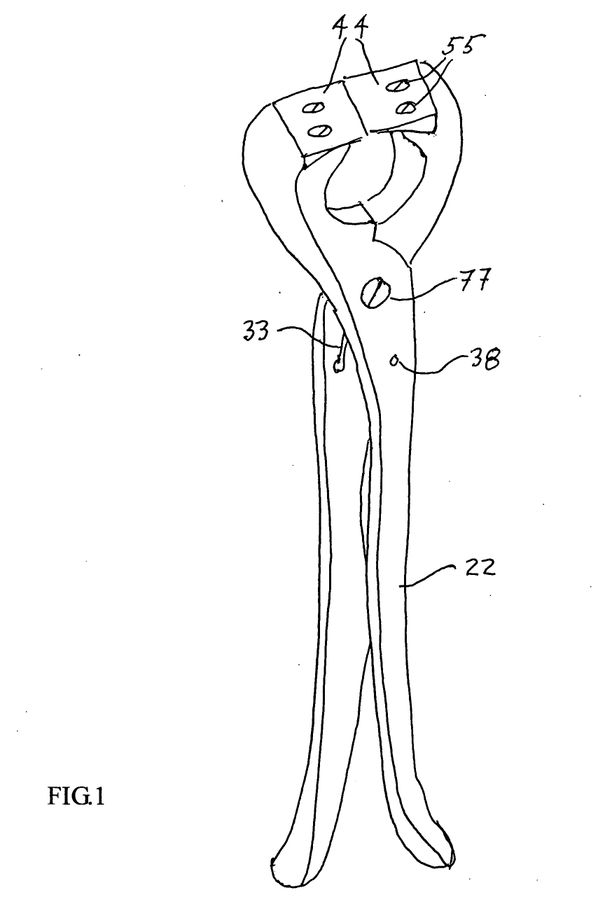

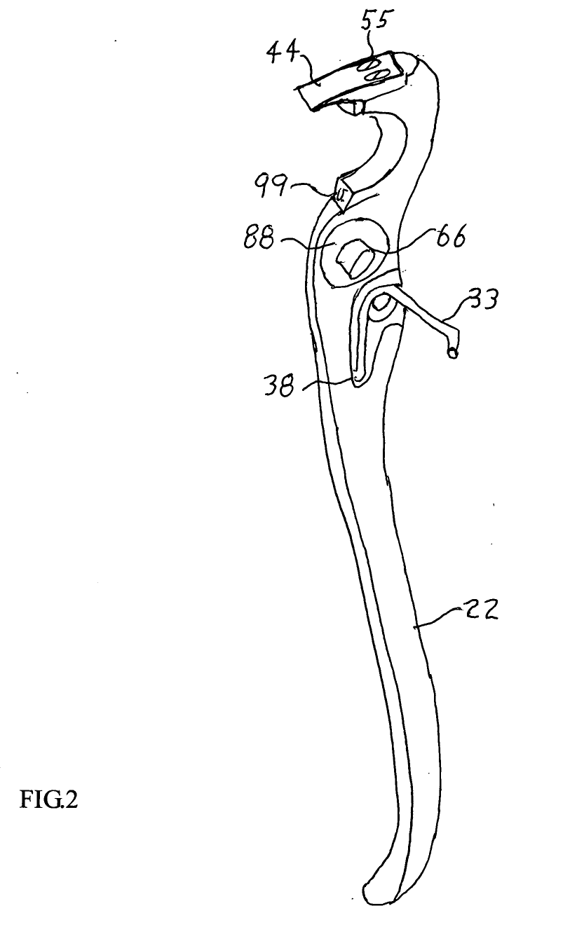

FIG. 1 is a perspective view of a torsion type spring 33 biased nipper with handles 22 spaced narrowly apart to allow a small hand to utilize them one-handed. Besides the handles themselves being parallel at a narrow spacing, the distal ends of the handles 22 are even closer together to allow the handles to be gripped with a narrower grip at the distal ends for greater leverage. FIG. 1 also shows the placement of the pivot screw 77. FIG. 1 also shows the mounting of the fastener affixed carbide blades 44 with countersunk screws 55. FIG. 1 also shows the spring anchor hole 38 where the leg of the spring will attach. FIG. 2 shows a perspective view of the interior side of the disclosed nipper with the recess for mounting the torsion spring 33, the hole for the pivot bushing 66, and the hole 38 for anchoring the end of the torsion spring 33. FIG. 2 also shows the polymer washer 88 mounted between the handles 22 to further reduce friction and wear. The torsion type spring 33 is used because it will allow narrow spacing of the handles 22. The torsion spring 33 is affixed to not only bias the handles open, but to restrict the handles 22 from falling fully open which would necessitate using two hands to regain a grip. When the handles 22 are squeezed together, the torsion spring 33 compresses as shown in FIG. 1 allowing the blades to meet and cut the desired material. When the handle pressure is relaxed, the torsion spring 33 is mounted so as to be fastened inside the handles 22 so that the spring pressure forces the handles open only to a predetermined width, approximately thirty degrees, that will allow easy use with one small hand. This torsion spring 33 is attached to the handles in such a way that also allows the handles to be manually spread further apart if required to make a thicker cut. A stop screw 77 mounted as shown in FIG. 2 allows regulation of the cutting blades 44 so that the blades meet without a gap and without excess pressure. The carbide blades 44 are affixed to the cutting head of the assembly with countersunk fasteners 55 recessed so they do not interfere with the cutting action and can be replaced anywhere as needed without commonly available tools rather than be resharpened. This is faster and easier for someone not skilled in sharpening cutter blades. The preferred embodiment of the disclosed nipper design shows the handle body forged to the shape in the drawings. The handles are close together and even more so at the distal end for better leverage with smaller hands. The handles would be forged from stainless steel which, being stronger, could be thinner and therefore lighter weight. The machining done on the nipper body would comprise shelves for the carbide blades which are drilled and tapped to match the blade fastener holes. An accurate bushing hole for the bushing pivot would be drilled and reamed. A friction reducing material such as oil impregnated bronze would be installed in the pivot hole and a polymer washer installed around that bushing to further reduce wear and friction between the two handles. The spring would be of adequate strength to hold the handles apart without requiring excessive force to close the handles. Recesses would be machined for the spring to be positioned inside the handle bodies. This protects the spring and reduces interference during use. Holes are drilled at the lower end of the recess in which the 90 degree leg of the spring is anchored.

In addition would be drilling and tapping for a small set screw located in the lower adjoining contacting faces to allow for adjustment of the blade contact. The handles would be covered with a non-slip rubber for safety and convenience. The blades would be vanadium carbide tool steel such as Crucible Metals CPM S30V or CPM S90V. The blades would be hollow ground on the cutting edge to require the least pressure to trim hooves. This carbide steel also would retain its sharpness enabling ease of use and longevity. The carbide steel blades would be drilled for the fasteners, hollow ground and then heat treated to approximately 60 Rockwell. The blades would be mounted with countersunk or counter-bored fasteners so they do not interfere with the cutting edge.

While the above description contains detailed specifications and instructions, these should not be construed as limitations on the scope of the invention, but rather as an exemplification of one preferred embodiment thereof. Many other variations are possible, such as forming the handles of polymer material, a simple flat v-spring, or blades of ceramic. Accordingly, the scope of the invention should be determined not by the embodiment illustrated, but by the appended claims and their legal equivalents.

What I claim is:

1: A cutting tool, comprising:
a pair of handle members elongated inwardly parallel to cross over planar at a pivot region and attached with a pivot means such that a cutting action is established perpendicularly at the head end by pivoting one distal handle member planar to the other, with a blade member fastener affixed to the cutting head of each handle members; and wherein the handle members are biased apart from the pivot point by a spring recessed between the handles which also limits the open distance between the handles at the distal end;
and wherein the distal ends of the handles are inwardly shaped to reduce the distance between the distal ends; and wherein the cutting blades are affixed with fasteners so as to be replaceable.

2. The cutting tool of claim one wherein the handle members composition is of a lightweight material.

3. The cutting tool of claim one wherein the replaceable blades are of a hard, tough material.

4. The cutting tool of claim one wherein the pivot bushing material is a friction reducing means.
